(19) United States
(12) Patent Application Publication
(10) Pub. No.: US 2006/0185688 A1
(43) Pub. Date: Aug. 24, 2006

(54) Semiconductor wafer cleaning method and wafer cleaned by same method

(75) Inventors: Satoshi Uematsu, Tokyo (JP); Hisashi Mashiyama, Tokyo (JP); Takehiko Tani, Tokyo (JP)

Correspondence Address: FOLEY AND LARDNER LLP;SUITE 500, 3000 K STREET NW, WASHINGTON, DC, 20007, US

(73) Assignee: HITACHI CABLE, LTD.

(21) Appl. No.: 11/324,228

(22) Filed: Jan. 4, 2006

(30) Foreign Application Priority Data
Feb. 24, 2005 (JP) 2005-049260

(51) Int. Cl. C23G 1/00; B08B 7/04; B08B 3/00

(52) U.S. Cl. 134/2; 134/34; 134/10

(57) ABSTRACT

A semiconductor wafer cleaning method has steps of cleaning a surface of a semiconductor wafer with a cleaning solution that has an etching function; and cleaning the surface of the semiconductor wafer with a high-purity organic solvent while circulating the high-purity organic solvent so as to remove Ca and Mg on the surface of the semiconductor wafer.

The present application is based on Japanese patent application No. 2005-049260, the entire contents of which are incorporated herein by reference.

### BACKGROUND OF THE INVENTION

1. Field of the Invention

This invention relates to a semiconductor wafer cleaning method and a semiconductor wafer cleaned by the same method.

2. Description of the Related Art

Compound semiconductors are used for various light receiving/emitting devices such as MESFET (metal semiconductor field effect transistor), HEMT (high electron mobility transistor) and HBT (heterojunction bipolar transistor).

Active layers in such devices are formed on a surface of a mirror polish wafer by MBE (molecular beam epitaxy), MOVPE (metalorganic vapor phase epitaxy) etc.

The mirror polish wafer is prepared as described below. A crystal ingot is sliced into a wafer. Then, the sliced wafer is lapped by alumina abrasives of #800 to #3000 to remove a saw mark and to flatten the wafer. Then, the wafer is mirror-finished in mechanochemical polishing by using a polishing solution such as hypochlorite solution or a mixture of hypochlorite solution and abrasives (silica, alumina or zirconium), and a polishing cloth with a porous layer on its surface. Then, the mirror surface is cleaned by a predetermined method, and dried.

FIG. 1 is a flow chart showing a conventional semiconductor wafer cleaning method.

As shown in FIG. 1, the conventional semiconductor wafer cleaning method comprises: step S11 where a semiconductor wafer with a mirror surface cleaned by degreasing is cleaned with a cleaning solution which has a slight etching function; step S12 to clean the wafer with ultrapure water; and step S13 to dry the wafer.

However, in this cleaning method, when an organic alkali cleaning solution is used as the cleaning solution which has the slight etching function, the cleaning solution slightly remains on the wafer surface (i.e., mirror surface). If a semiconductor layer is epitaxially grown on the mirror surface, a haze may be generated on the surface of the epitaxial layer. Thus, the epitaxial layer does not have a good surface. Therefore, in order to prevent the generation of the haze, the mirror surface of the wafer must be pretreated by etching etc. before growing the epitaxial layer.

JP-A-2004-087666 discloses a method that, in order to prevent a residual organic alkali cleaning solution on the surface of a semiconductor wafer, the surface of the semiconductor wafer is cleaned by an organic solvent after it is cleaned with the organic alkali cleaning solution.

However, JP-A-2004-087666 only relates to the prevention of the residual cleaning solution (e.g., organic alkali cleaning solution) on the surface of the semiconductor wafer after the cleaning, and it does not disclose or suggest the removal of a light metal such as calcium (Ca) and magnesium (Mg).

Of inorganic substances, Ca and Mg exist widely in human body, and a tool such as a glove and gauze, and they are most likely to contaminate the semiconductor wafer. In the conventional cleaning method as shown in FIG. 1, a slight amount of Ca or Mg contaminated in the cleaning solution through a jig or a cleaning carrier etc. may be attached onto the wafer surface and dried as they are. Thus, Mg or Ca will remain on the wafer surface.

In growing an epitaxial layer on such a wafer surface, the characteristics of the epitaxial layer may be affected by the residual Mg or Ca, for example, the epitaxial layer may be subjected to abnormality in carrier concentration.

Thus, in order to prevent the abnormality in the epitaxial layer, the mirror surface of the wafer still needs to be pretreated by etching before growing the epitaxial layer thereon.

### SUMMARY OF THE INVENTION

It is an object of the invention to provide a semiconductor wafer cleaning method that Mg and Ca on the surface of a wafer can be effectively removed during the cleaning process.

(1) According to one aspect of the invention, a semiconductor wafer cleaning method comprises:

cleaning a surface of a semiconductor wafer with a cleaning solution that has an etching function; and

cleaning the surface of the semiconductor wafer with a high-purity organic solvent while circulating the high-purity organic solvent so as to remove Ca and Mg on the surface of the semiconductor wafer.

In the above invention, the following modifications and changes can be made.

(i) The high-purity organic solvent comprises a solvent of isopropyl alcohol, methyl alcohol, ethyl alcohol and acetone.

(ii) The high-purity organic solvent comprises a purity of 99.99% or higher.

(iii) The high-purity organic solvent is circulated at a flow rate of 10 litter/min. or higher.

(iv) The cleaning solution is an organic alkali cleaning solution.

(v) The semiconductor wafer comprises a group III-V-based compound semiconductor or group II-VI-based compound semiconductor.

(vi) The group III-V-based compound semiconductor comprises GaAs or semi-insulating GaAs.

(2) According to another aspect of the invention, a semiconductor wafer comprises:

a compound semiconductor,

wherein the compound semiconductor comprises a group. III-V-based compound semiconductor or group II-VI-based compound semiconductor, and

none of Ca and Mg substantially remains on a surface of said semiconductor wafer by applying the semiconductor wafer cleaning method as defined in above (1) to said semiconductor wafer.

In the above invention, the following modifications and changes can be made.

(vii) The high-purity organic solvent comprises a solvent of isopropyl alcohol, methyl alcohol, ethyl alcohol and acetone.

(viii) The high-purity organic solvent comprises a purity of 99.99% or higher.

(ix) The high-purity organic solvent is circulated at a flow rate of 10 litter/min. or higher.

(x) The group III-V-based compound semiconductor comprises GaAs or semi-insulating GaAs.

<Solutions of the Invention>

As described earlier, the abnormality in characteristics of the epitaxial layer is caused by that the impurities, Mg and Ca remain on the surface of the epitaxial layer. To solve this problem, in the invention, at a final stage of the wafer cleaning process, the residual Mg and Ca on the surface of the wafer are removed perfectly. Namely, a means (process) for removing the residual Mg and Ca is that the semiconductor wafer is cleaned with the high-purity organic solvent such as isopropyl alcohol at the final stage of the cleaning process, i.e., after it is cleaned with an organic alkali solvent such as organic amine that has a slight etching function and then cleaned with ultrapure water. Thereby, the residual Mg and Ca on the surface of the wafer can be perfectly removed, and a high-quality epitaxial wafer can be obtained.

In the invention, it is confirmed that the removing of Ca and Mg can be preferably effected by that i) the high-purity organic solvent such as IPA is used, and ii) the high-purity organic solvent is circulated at a flow rate of 10 litter/min or higher.

<Advantages of the Invention>

In the invention, at the final stage of the semiconductor wafer cleaning process, the semiconductor wafer is cleaned with the high-purity organic solvent. Thereby, the residual Mg and Ca on the surface of the wafer can be perfectly removed, and a high-quality epitaxial wafer can be obtained.

Thus, it is advantageous in economical aspect that no additional apparatus is required to conduct the semiconductor wafer cleaning method of the invention.

By using the wafer obtained by the invention, a high-quality device can be stably produced. Therefore, the yield of the device can be enhanced.

### BRIEF DESCRIPTION OF THE DRAWINGS

The preferred embodiments according to the invention will be explained below referring to the drawings, wherein:

FIG. 1 is a flow chart showing the process of the conventional semiconductor wafer cleaning method; and

FIG. 2 is a flow chart showing the process of a semiconductor wafer cleaning method in a preferred embodiment according to the invention.

### DETAILED DESCRIPTION OF THE PREFERRED EMBODIMENTS

In the preferred embodiment of the invention, at a final stage in a process of cleaning a semiconductor wafer, a high-purity organic solvent such as isopropyl alcohol is used to clean the surface of the semiconductor wafer so as to remove Mg and Ca on the surface of the semiconductor.

FIG. 2 is a flow chart showing the process of a semiconductor wafer cleaning method in the preferred embodiment according to the invention.

In the semiconductor wafer cleaning method, a GaAs ingot of group III-V-based compound semiconductor is sliced into a wafer and mirror-polished, and the polished GaAs wafer is subjected to the method.

At first, the GaAs wafer is cleaned by degreasing, and the mirror surface of the GaAs wafer is cleaned for 5 min. with an organic alkali cleaning solution (e.g., organic amine) which has a slight etching function (step S1). Then, it is washed with ultrapure water (step S2).

Then, by using a high-purity organic solvent, IPA (isopropyl alcohol), the mirror surface of the GaAs wafer is cleaned for 5 min. (step S3) and washed again for 5 min. with ultrapure water (step S4). Then, it is dried by the IPA vapor drying method or spin drying method (step S5).

### Inventive Example 1

A semi-insulating GaAs wafer with a mirror surface in Inventive Example 1 is cleaned with the alkali cleaning solvent, i.e., organic amine, with Mg contaminated therein, and then it is cleaned in the cleaning sequence as shown in FIG. 2, where IPA with a purity of 99.99% is used as the high-purity organic solvent.

The wafer of Inventive Example 1 is analyzed by a time-of-flight secondary ion mass spectrometer to detect the amount of Ca and Mg on the surface of the wafer. As a result, none of Ca and Mg is detected. The cleaning conditions of Inventive Example 1 are as shown in Table 1.

TABLE 1

| | Alkali | | | |
|---|---|---|---|---|
| | cleaning | | | |
| Cleaning liquid | solvent | Pure water | IPA | Pure water |
| Cleaning time | 5 min | 5 min | 5 min | 5 min |
| Flow rate | 10 l/min | 5 l/min | 10 l/min | 5 l/min |
| | (circulated) | (overflowed) | (circulated) | (overflowed) |

### Comparative Example 1

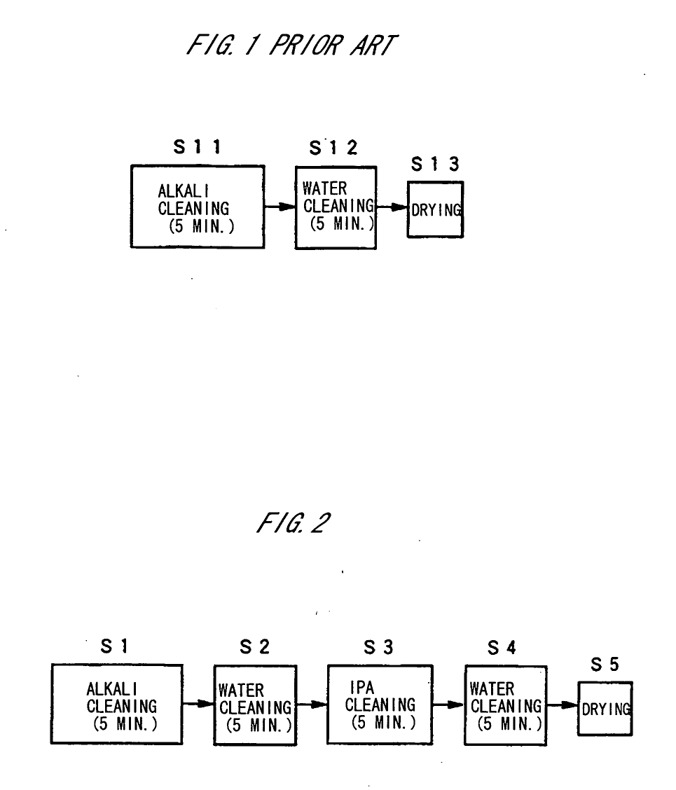

For the sake of comparison, a semi-insulating GaAs wafer with a mirror surface in Comparative Example 1 is cleaned with the alkali cleaning solvent, i.e., organic amine, with Mg contaminated therein, and then it is cleaned in the cleaning sequence (without having steps S3 and S4) as shown in FIG. 1. The wafer of Comparative Example 1 is analyzed by the time-of-flight secondary ion mass spectrometer to detect the amount of Ca and Mg on the surface of the wafer. As a result, Mg and Ca are detected.

The cleaning conditions of Comparative Example 1 are as shown in Table 2.

TABLE 2

| | Alkali | |
|---|---|---|
| | cleaning | |
| Cleaning liquid | solvent | Pure water |
| Cleaning time | 5 min | 5 min |
| Flow rate | 10 l/min | 5 l/min |
| | (circulated) | (overflowed) |

### Inventive Example 2

A semi-insulating GaAs wafer with a mirror surface in inventive example 2 is cleaned with the alkali cleaning solvent, i.e., organic amine, with Ca contaminated therein, and then it is cleaned in the cleaning sequence as shown in FIG. 2, where IPA with a purity of 99.99% is used as the high-purity organic solvent. The wafer of Inventive Example 2 is analyzed by the time-of-flight secondary ion mass spectrometer to detect the amount of Ca and Mg on the surface of the wafer. As a result, none of Ca and Mg is detected.

The cleaning conditions of Inventive Example 2 are as shown in Table 3.

TABLE 3

| | Alkali | | | |
|---|---|---|---|---|
| | cleaning | | | |
| Cleaning liquid | solvent | Pure water | IPA | Pure water |
| Cleaning time | 5 min | 5 min | 5 min | 5 min |
| Flow rate | 10 l/min | 5 l/min | 10 l/min | 5 l/min |
| | (circulated) | (overflowed) | (circulated) | (overflowed) |

### Comparative Example 2

For the sake of comparison, a semi-insulating GaAs wafer with a mirror surface in Comparative Example 2 is cleaned with the alkali cleaning solvent, organic amine, with Ca contaminated therein, and then it is cleaned in the cleaning sequence (without having steps S3 and S4) as shown in FIG. 1. The wafer of Comparative Example 2 is analyzed by the time-of-flight secondary ion mass spectrometer to detect the amount of Ca and Mg on the surface of the wafer. As a result, Mg and Ca are detected.

The cleaning conditions of Comparative Example 2 are as shown in Table 4.

TABLE 4

| | Alkali | |
|---|---|---|
| | cleaning | |
| Cleaning liquid | solvent | Pure water |
| Cleaning time | 5 min | 5 min |
| Flow rate | 10 l/min | 5 l/min |
| | (circulated) | (overflowed) |

### Comparative Example 3

A semi-insulating GaAs wafer with a mirror surface in Comparative Example 3 is cleaned with the alkali cleaning solvent, i.e., organic amine, with Mg contaminated therein, and then it is cleaned in the cleaning sequence as shown in FIG. 2 except that IPA is circulated at a flow rate of 5 litter/min, where IPA with a purity of 99.99% is used as the high-purity organic solvent.

The wafer of Comparative Example 3 is analyzed by a time-of-flight secondary ion mass spectrometer to detect the amount of Ca and Mg on the surface of the wafer. As a result, a very small amount of Ca and Mg is detected.

The cleaning conditions of Comparative Example 3 are as shown in Table 5.

TABLE 5

| | Alkali | | | |
|---|---|---|---|---|
| | cleaning | | | |
| Cleaning liquid | solvent | Pure water | IPA | Pure water |
| Cleaning time | 5 min | 5 min | 5 min | 5 min |
| Flow rate | 10 l/min | 5 l/min | 5 l/min | 5 l/min |
| | (circulated) | (overflowed) | (circulated) | (overflowed) |

In view of Examples described above, it is confirmed that Ca and Mg can be effectively removed from the wafer surface by the semiconductor wafer cleaning method of the embodiment as shown in FIG. 2. Especially, the removing of Ca and Mg can be preferably effected by that i) the high-purity organic solvent such as IPA is used, and ii) the high-purity organic solvent is circulated at a flow rate of 10 litter/min or higher.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A semiconductor wafer cleaning method, comprising:
cleaning a surface of a semiconductor wafer with a cleaning solution that has an etching function; and
cleaning the surface of the semiconductor wafer with a high-purity organic solvent while circulating the high-purity organic solvent so as to remove Ca and Mg on the surface of the semiconductor wafer.

2. The semiconductor wafer cleaning method according to claim 1, wherein:
said high-purity organic solvent comprises a solvent of isopropyl alcohol, methyl alcohol, ethyl alcohol and acetone.

3. The semiconductor wafer cleaning method according to claim 1, wherein:
said high-purity organic solvent comprises a purity of 99.99% or higher.

4. The semiconductor wafer cleaning method according to claim 1, wherein:
said high-purity organic solvent is circulated at a flow rate of 10 litter/min. or higher.

5. The semiconductor wafer cleaning method according to claim 1, wherein:
said cleaning solution is an organic alkali cleaning solution.

6. The semiconductor wafer cleaning method according to claim 1, wherein:
said semiconductor wafer comprises a group III-V-based compound semiconductor or group II-VI-based compound semiconductor.

7. The semiconductor wafer cleaning method according to claim 6, wherein:
said group III-V-based compound semiconductor comprises GaAs or semi-insulating GaAs.

8. A semiconductor wafer, comprising:
a compound semiconductor,
wherein the compound semiconductor comprises a group III-V-based compound semiconductor or group II-VI-based compound semiconductor, and
none of Ca and Mg substantially remains on a surface of said semiconductor wafer by applying the semiconductor wafer cleaning method as defined in claim 1 to said semiconductor wafer.

9. The semiconductor wafer according to claim 8, wherein:
said high-purity organic solvent comprises a solvent of isopropyl alcohol, methyl alcohol, ethyl alcohol and acetone.

10. The semiconductor wafer according to claim 8, wherein:
said high-purity organic solvent comprises a purity of 99.99% or higher.

11. The semiconductor wafer according to claim 8, wherein:
said high-purity organic solvent is circulated at a flow rate of 10 litter/min. or higher.

12. The semiconductor wafer according to claim 8, wherein:
said group III-V-based compound semiconductor comprises GaAs or semi-insulating GaAs.
